(19) United States
(12) Patent Application Publication
(10) Pub. No.: US 2006/0290847 A1
(43) Pub. Date: Dec. 28, 2006

(54) Liquid crystal display

(75) Inventor: Jae-Hyun Kim, Suwon-si (KR)

Correspondence Address: F. CHAU & ASSOCIATES, LLC, 130 WOODBURY ROAD, WOODBURY, NY, 11797, US

(73) Assignee: Samsung Electronics Co., LTD., Suwon-si (KR)

(21) Appl. No.: 11/474,785

(22) Filed: Jun. 26, 2006

(30) Foreign Application Priority Data
Jun. 24, 2005 (KR) 10-2005-0054845

(51) Int. Cl. G02F 1/1335

(52) U.S. Cl. 349/113

(57) ABSTRACT

A liquid crystal display is provided with a reflective polarizer and an optical retarder between an absorbing polarizer and a backlight unit. This structure recycles light that would ordinarily be removed by absorption in conventional LCDs to be used for the display, so that light efficiency and display luminance of the LCD are improved.

### CROSS REFERENCE TO RELATED FOREIGN APPLICATION

This Application claims priority from a Korean patent application number 10-2005-0054845 filed on Jun. 24, 2005and all the benefits accruing therefrom under 35 U.S.C. §119, the contents of which are incorporated by reference herein in their entirety.

### BACKGROUND OF THE INVENTION

(a) Field of the Invention The present invention relates to a liquid crystal display (LCD).

(b) Description of the Related Art Generally, an LCD includes a pair of panels individually having electrodes on their inner surfaces, and a dielectric anisotropy liquid crystal (LC) layer interposed between the panels. In an LCD, a variation of the voltage difference between the field generating electrodes, i.e., the variation in the strength of an electric field generated by the electrodes, changes the transmittance of the light passing through the LC layer, and thus desired images are obtained by controlling the voltage difference between the electrodes.

Depending on the kinds of light source used for image display, LCDs are divided into three types: transmissive, reflective, and transflective. In transmissive LCDs, pixels are illuminated from behind using a backlight. In reflective LCDs, the pixels are illuminated from the front using incident light originating from the ambient environment. The transflective LCDs combine transmissive and reflective characteristics. Under medium light conditions such as an indoor environment, or under complete darkness conditions, transflective LCDs are operated in a transmissive mode, while under very bright conditions, such as an outdoor environment, they are operated in a reflective mode.

The transmissive LCD and the transflective LCD are popularly used in the sphere of LCDs since they show relatively high display luminance compared to the reflective LCD.

However, in these two types of LCD, a polarizer attached to a lower surface of the LCD absorbs about 50% of light emitted from the backlight, and therefore only the remaining 50% is used for the display. As a result, light efficiency and display luminance of the transmissive/transflective LCD are less than optimal.

### SUMMARY OF THE INVENTION

According to an aspect of the present invention, there is provided an LCD including a display panel, a reflective polarizer that is provided under the display panel to transmit light that is linearly polarized in a first direction and to reflect light that is linearly polarized in a second direction perpendicular to the first direction, an optical retarder that is provided under the reflective polarizer, and a backlight unit that is provided under the optical retarder and that includes a light source for supplying light to the display panel.

In this structure, the reflective polarizer is made of alternating layers of two media having different indices of refraction in the first direction, and the same index of refraction in the second direction.

The LCD may further include a first absorbing polarizer that is provided between the display panel and the reflective polarizer, and a transmission axis of the first absorbing polarizer may be in the first direction.

The LCD may further include a second absorbing polarizer that is attached to an upper surface of the display panel, and a transmission axis of the second absorbing polarizer may be in the second direction.

The optical retarder has a slow axis and a fast axis, and a phase difference between the two axes may be a quarter-wave to convert circularly polarized light into linearly polarized light or linearly polarized light into circularly polarized light. The fast axis or the slow axis of the optical retarder may be formed at ±45° to the first direction or the second direction.

The backlight unit may further include a reflective plate for reflecting light toward the display panel that is provided above the backlight unit.

According to another aspect of the present invention, there is provided an LCD which includes a display panel, a reflective polarizer that is provided under the display panel and includes a selective reflection film that transmits light that is linearly polarized in a first direction and reflects light that is linearly polarized in a second direction perpendicular to the first direction and an optical retardation film that is coated on a lower surface of the selective reflection film, and a backlight unit that is provided under the reflective polarizer and includes a light source for supplying light to the display panel.

Here, the reflective polarizer is made of alternating layers of two media having different indices of refraction in the first direction and the same index of refraction in the second direction.

The LCD may further include a first absorbing polarizer that is provided between the display panel and the reflective polarizer, and a transmission axis of the first absorbing polarizer may be in the first direction.

The LCD may further include a second absorbing polarizer that is attached to an upper surface of the display panel, and a transmission axis of the second absorbing polarizer may be in the second direction.

The optical retardation film has a slow axis and a fast axis, and a phase difference between the two axes may be a quarter-wave to convert circularly polarized light into linearly polarized light or linearly polarized light into circularly polarized light. The fast axis or the slow axis of the optical retardation film may be formed at ±45° to the first direction or the second direction.

The optical retardation film may be obtained by curing liquid crystal.

The backlight unit may further include a reflective plate for reflecting light toward the display panel that is provided above the backlight unit.

### BRIEF DESCRIPTION OF THE DRAWINGS

FIG. 1 is a layout view of a thin film transistor (TFT) array panel of an LCD according to an embodiment of the present invention.

FIG. 2 is a layout view of a common electrode panel of an LCD according to an embodiment of the present invention.

FIG. 3 is a layout view of an LCD incorporating the TFT array panel of FIG. 1 and the common electrode panel of FIG. 2.

FIG. 4 is a schematic cross-sectional view cut along IV-IV′ of FIG. 3.

FIG. 5 shows schematic cross sections cut along V-V′ and V′-V″ of FIG. 3, respectively.

FIG. 6 shows a schematic cross-sectional view of an LCD according to an embodiment of the present invention.

FIG. 7 is a view for comparing light efficiency and light paths between portions with and without a reflective polarizer and an optical retarder in an LCD according to the present invention.

FIG. 8 shows the polarization states of light in the LCD of FIG. 6.

FIG. 9 shows a schematic cross-sectional view of an LCD according to another embodiment of the present invention.

FIG. 10 shows the polarization states of light in the LCD of FIG. 9.

FIG. 11 is a perspective view of a reflective polarizer according to an embodiment of the present invention.

FIG. 12 shows an optical path of light reflected by a reflective polarizer according to an embodiment of the present invention.

FIG. 13 is a perspective view showing a basic structure of a reflective polarizer according to an embodiment of the present invention.

FIG. 14 is a graph showing reflection and transmission characteristics of a reflective polarizer according to an embodiment of the present invention.

### DETAILED DESCRIPTION OF THE EXEMPLARY EMBODIMENTS

Exemplary embodiments of the present invention will be described more fully hereinafter with reference to the accompanying drawings, in which exemplary embodiments of the invention are shown. The present invention may, however, be embodied in different forms and should not be construed as being limited to the embodiments set forth herein.

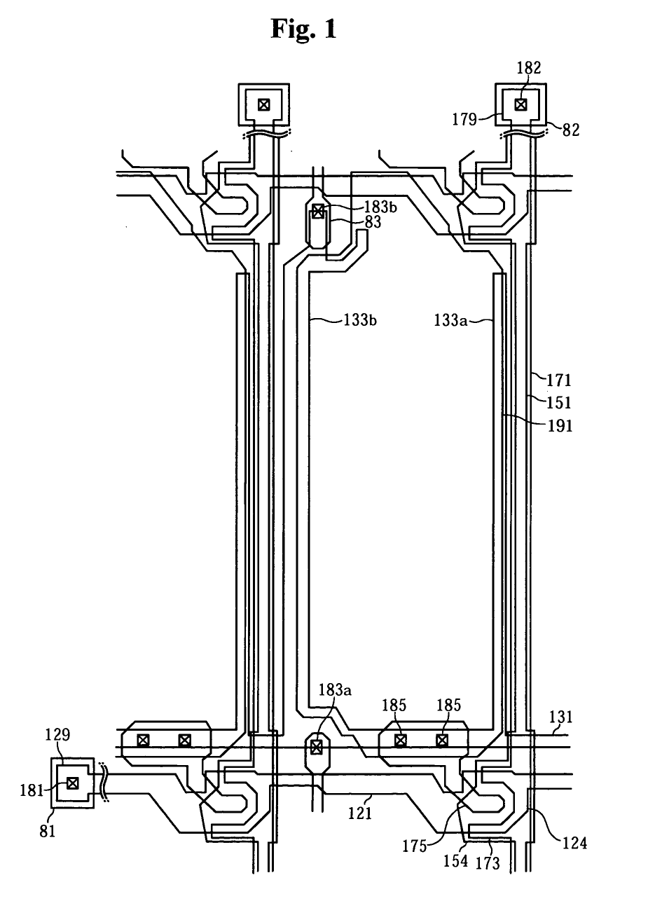

Hereinafter, an LCD according to an exemplary embodiment of the present invention will be described in detail with reference to FIG. 1 through FIG. 5.

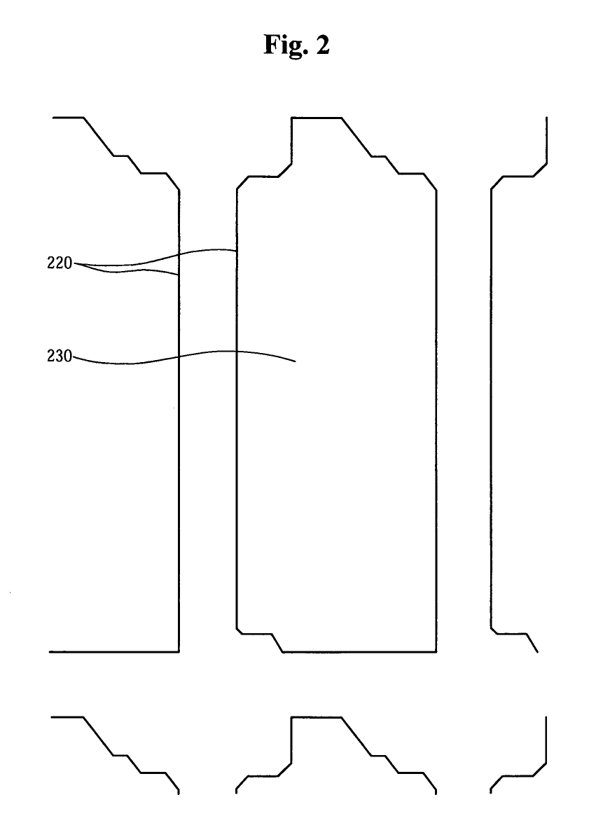

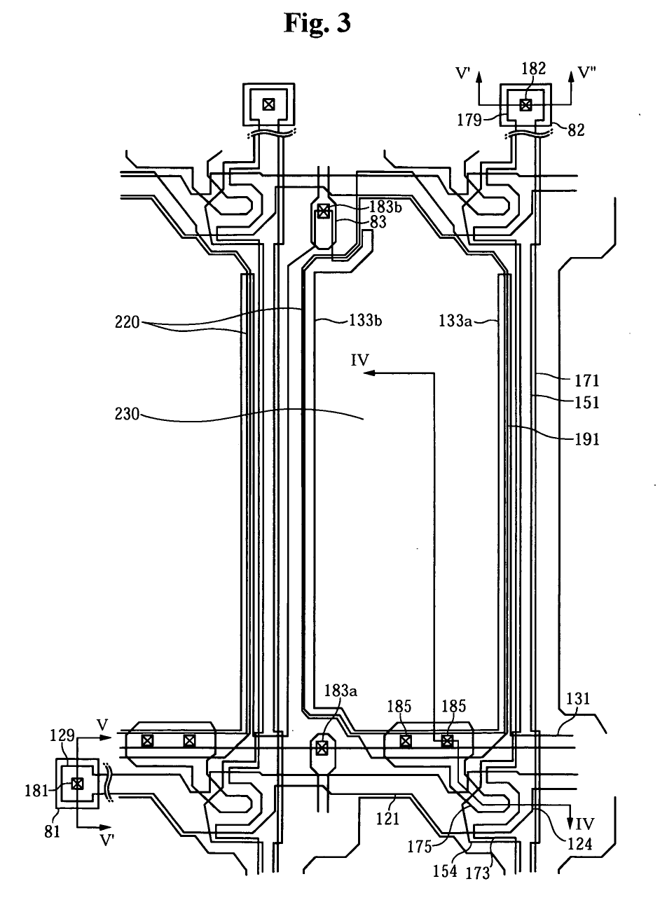

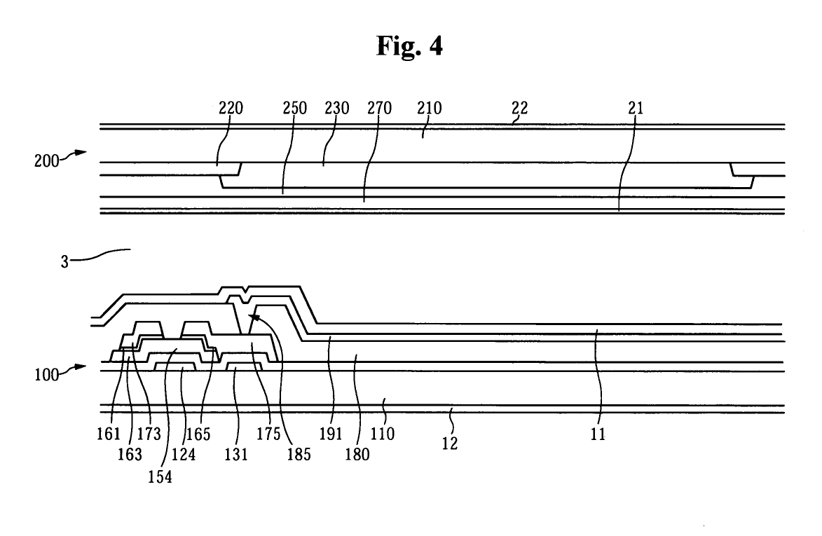

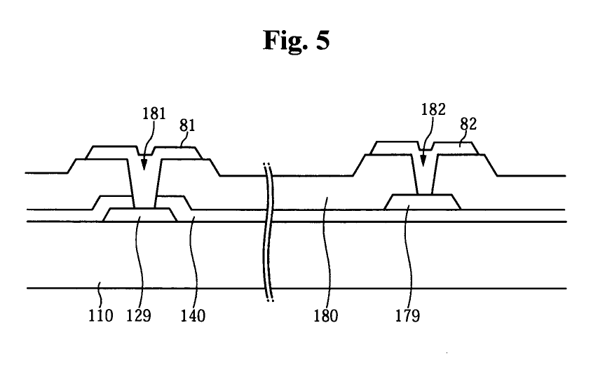

FIG. 1 is a layout view of a thin film transistor (TFT) array panel of an LCD according to an embodiment of the present invention, FIG. 2 is a layout view of a common electrode panel of an LCD according to an embodiment of the present invention, FIG. 3 is a layout view of an LCD incorporating the TFT array panel of FIG. 1 and the common electrode panel of FIG. 2, FIG. 4 is a cross-sectional view cut along IV-IV′ of FIG. 3, and FIG. 5 shows cross sections cut along V-V′ and V′-V″ of FIG. 3, respectively.

Referring to FIG. 1 through FIG. 5, an LCD according to an embodiment of the present invention comprises a TFT array panel 100 and a common electrode panel 200 facing each other, and an LC layer 3 interposed therebetween.

First, the basic structure of the TFT array panel 100 is described below with reference to FIG. 1, FIG. 3, and FIG. 5.

A plurality of gate lines 121 and a plurality of storage electrode lines 131 are formed on an insulating substrate 110 made of transparent glass or plastic.

The gate lines 121 for transmitting gate signals extend substantially in a horizontal direction. Each gate line 121 includes a plurality of gate electrodes 124 protruding downward and an end portion 129 having a relatively large dimension to be connected to a different layer or an external device. Gate drivers (not shown) for generating the gate signals may be mounted on a flexible printed circuit film (not shown) attached to the substrate 110, or directly on the substrate 110. Otherwise, the gate drivers may be integrated into the substrate 110. In this case, the gate lines 121 are directly connected to the gate drivers.

The storage electrode lines 131 receive a predetermined voltage. Each storage electrode line 131 comprises a stem line that is substantially parallel to the gate lines 121 and a plurality of pairs of storage electrodes 133a and 133b that extend from the stem line substantially in a vertical direction. Each storage electrode line 131 is placed between two adjacent gate lines 121. The stem line of the storage electrode line 131 is closer to the lower-positioned gate line of the two. Each storage electrode 133a has a fixed end that is connected to one of the stem lines and a free end. Each storage electrode 133b has a fixed end with a relatively large dimension, which is connected to one of the stem lines, and two free ends including a straight free end and a crooked free end. However, the form and arrangement of the storage electrode lines 131 may be diversely varied.

The gate lines 121 and the storage electrode lines 131 can be made of an aluminum- (Al) containing metal such as Al and an Al alloy, a silver- (Ag) containing metal such as Ag and a Ag alloy, a copper- (Cu) containing metal such as Cu and a Cu alloy, a molybdenum- (Mo) containing metal such as Mo and a Mo alloy, chrome (Cr), titanium (Ti), ortantalum (Ta). The gate lines 121 and the storage electrode lines 131 may be configured as a multi-layered structure, in which at least two conductive layers (not shown) having different physical properties are included. In such a structure, one of the two conductive layers is made of a low resistivity metal, such as an Al-containing metal, an Ag-containing metal, a Cu-containing metal, or the like, in order to reduce delay of the signals or voltage drop in the gate lines 121 and the storage electrode lines 131. The other conductive layer is made of a material having prominent physical, chemical, and electrical contact properties with other materials such as indium tin oxide (ITO) and indium zinc oxide (IZO). For example, a Mo containing metal, Cr, Ta, Ti, etc., may be used for the formation of the same layer. Desirable examples of the combination of the two layers are a lower Cr layer and an upper Al (or Al alloy) layer, and a lower Al (or Al alloy) layer and an upper Mo (or Mo alloy) layer. Besides the above-listed materials, various metals and conductors can be used for the formation of the gate lines 121 and the storage electrode lines 131.

All lateral sides of the gate lines 121 and the storage electrode lines 131 can slope in the range from about 300 to 800 to the surface of the substrate 110.

A gate insulating layer 140 made of silicon nitride (SiNx) or silicon oxide (SiO₂), is formed on the gate lines 121 and the storage electrode lines 131.

A plurality of linear semiconductors 151 made of hydrogenated amorphous silicon (abbreviated as “a-Si”) or polysilicon are formed on the gate insulating layer 140. Each linear semiconductor 151 extends substantially in a vertical direction, including a plurality of projections 154 that extend along the respective gate electrodes 124. The linear semiconductors 151 are enlarged in the vicinities of the gate lines 121 and the storage electrode lines 131 to cover them widely.

A plurality of linear ohmic contacts 161 and island-shaped ohmic contacts 165 are formed on the linear semiconductors 151. The ohmic contacts 161 and 165 may be made of N+hydrogenated amorphous silicon that is highly doped with N-type impurities such as phosphorus (P), or silicide. The linear ohmic contacts 161 include a plurality of projections 163. A set of a projection 163 and an island-shaped ohmic contact 165 is placed on the projection 154 of the semiconductor 151.

All lateral sides of the linear semiconductors 151 and the ohmic contacts 161 and 165 can slope in the range from about 30° to 80° to the surface of the substrate 110.

A plurality of data lines 171 and a plurality of drain electrodes 175 are formed on the ohmic contacts 161 and 165 and the gate insulating layer 140.

The data lines 171 for transmitting data signals extend substantially in a vertical direction to be crossed with the gate lines 121 and the stem lines of the storage electrode lines 131. Each pair of the storage electrodes 133a and 133b is placed between two adjacent data lines 171. Each data line 171 includes a plurality of source electrodes 173 extending toward the respective gate electrodes 124, and an end portion 179 having a relatively large dimension to be connected to a different layer or an external device. Data drivers (not shown) for generating the data signals may be mounted on a flexible printed circuit film (not shown) attached to the substrate 110, or directly on the substrate 110. Otherwise, the data drivers may be integrated into the substrate 110. In this case, the data lines 171 are directly connected to the gate drivers.

The drain electrodes 175 are opposite to the source electrodes 173, centering on the gate electrodes 124. Each drain electrode 175 includes an expansion having a relatively large dimension and a bar-shaped end portion that is partially surrounded by the curved source electrode 173.

A gate electrode 124, a source electrode 173, a drain electrode 175, and a projection 154 of the semiconductor 151 form a TFT. A TFT channel is formed in the projection 154 provided between the source electrode 173 and the drain electrode 175.

The data lines 171 and the drain electrodes 175 can be made of a refractory metal such as Mo, Cr, Ta, or Ti, or alloys thereof, and may be configured as multi-layered structures including a refractory metal layer (not shown) and a low resistivity conductive layer (not shown). A desirable example of the multi-layered structure is a lower layer made of one of Cr, Mo, or a Mo alloy, and an upper layer made of Al or an Al alloy. Another example is a lower layer made of Mo or a Mo alloy, an intermediate layer made of Al or an Al alloy, and an upper layer made of Mo or a Mo alloy. Besides the above-listed materials, various metals and conductors can be used for the formation of the data lines 171 and the drain electrodes 175.

All lateral sides of the data lines 171 and the drain electrodes 175 can slope in the range from about 30° to 80° to the surface of the substrate 110.

The ohmic contacts 161 and 165 exist only between the underlying semiconductors 151 and the overlying data lines 171 and between the overlying drain electrodes 175 and the underlying semiconductors 151, in order to reduce contact resistance therebetween. Most of the linear semiconductors 151 are formed more narrowly than the data lines 171, but partial portions thereof are enlarged in the vicinities of places to be crossed with the gate lines 121 or the storage electrode lines 131, as previously mentioned, in order to prevent the data lines 171 from being shorted. The linear semiconductors 151 are partially exposed at places where the data lines 171 and the drain electrodes 175 do not cover them, as well as between the source electrodes 173 and the drain electrodes 175.

A passivation layer 180 is formed on the data lines 171, the drain electrodes 175, and the exposed portions of the semiconductors 151. A top surface of the passivation layer 180 may be flat. The passivation layer 180 may be configured as a single layer made of an inorganic insulator, such as SiNx or SiO₂, or an organic insulator. In this case, a desirable organic insulator for the passivation layer 180 has a low dielectric constant of below 4.0 and/or a low photosensitivity. The passivation layer 180 may also be configured as a double-layered structure including a lower inorganic insulator layer and an upper organic insulator layer. This structure has a prominent insulating property, allowing no damage to the exposed portions of the semiconductors 151.

The passivation layer 180 is provided with a plurality of contact holes 182 and 185, through which the end portions 179 of the data lines 171 and the expansions of the drain electrodes 175 are exposed, respectively. A plurality of contact holes 181 are formed in the passivation layer 180 and the gate insulating layer 140, and the end portions 129 of the gate lines 121 are exposed therethrough.

A plurality of pixel electrodes 191, a plurality of overpasses 83, and a plurality of contact assistants 81 and 82 are formed on the passivation layer 180. They may be made of a transparent conductor, such as ITO or IZO, or a reflective metal, such as Al, Ag, Cr, or their alloys.

The pixel electrodes 191 are physically and electrically connected to the drain electrodes 175 through the contact holes 185 in order to receive data voltages from the drain electrodes 175. The pixel electrodes 191 supplied with the data voltages generate electric fields in cooperation with a common electrode 270 of the common electrode panel 200, determining the orientations of LC molecules in the LC layer 3 interposed between the two electrodes 191 and 270. According to the orientations of the LC molecules, the polarization of light passing through the LC layer 3 is varied. Each set of the pixel electrode 191 and the common electrode 270 forms an LC capacitor capable of storing the applied voltage after the TFT is turned off.

To enhance the voltage storage ability of the LC capacitors, storage capacitors are further provided. The pixel electrodes 191 and the expansions of the drain electrodes 175 that are connected to the pixel electrodes 191 through the contact holes 182 and 185 are overlapped with the storage electrodes 133a and 133b as well as the stem lines of storage electrodes 131. Overlapping of the pixel electrodes 191 and the drain electrodes 175 electrically connected thereto with the storage electrode lines 131 implements the storage capacitors.

The contact assistants 81 and 82 are connected to the end portions 129 of the gate lines 121 and the end portions 179 of the data lines 171 through the contact holes 181 and 182, respectively. The contact assistants 81 and 82 supplement adhesion between the exposed end portions 129 and 179 and exterior devices, and protect them.

The overpasses 83 span the gate lines 121. Each pair of the overpasses 83, adjacent to each other upward and downward, are individually connected to the exposed stem line of the storage electrode line 131 and the exposed straight free end of the storage electrode 133b through contact holes 183a and 183b. The overpasses 83 and the storage electrode lines 131 having the storage electrodes 133a and 133b may be used for repairing any defect arising in the gate lines 121 and/or the data lines 171.

The basic structure of the common electrode panel 200 is described below with reference to FIG. 2 and FIG. 4.

A light-blocking member 220 called “a black matrix” is provided on an insulating substrate 210 made of transparent glass or plastic. The light-blocking member 220 consists of portions corresponding to the gate lines 121, the date lines 171, and the TFTs, to prevent light from leaking out through barriers between the pixel electrodes 191.

A plurality of color filters 230 are formed on the substrate 210 having the light-blocking member 220. Most of them are placed within aperture regions delimited by the light-blocking member 220. The color filters 230 may extend along the respective pixel electrodes 191 in a vertical direction. Each color filter 220 may exhibit one of red, green, or blue colors.

An overcoat layer 250 is formed on the light-blocking member 220 and the color filters 230 to prevent the color filters 230 from being exposed and to offer a flat surface. The overcoat layer 250 may be made of an organic insulator. The overcoat layer 250 may be omitted.

The common electrode 270, made of a transparent conductor such as ITO or IZO, is formed on the overcoat layer 250.

Alignment layers 11 and 21 are individually coated on the inner surfaces of the panels 100 and 200. They may be vertical alignment layers.

Polarizers 12 and 22 are individually attached to the outer surfaces of the panels 100 and 200. Their transmission axes are mutually crossed at a right angle. Here, either of the transmission axes can be parallel to the gate lines 121.

The LC molecules in the LC layer 3 have negative dielectric anisotropy. In the absence of an electric field, they are aligned substantially perpendicular to the surfaces of the two panels 100 and 200. In this case, incident light cannot pass through the polarizers 12 and 22 whose directions of polarization are mutually perpendicular.

When the common electrode 270 is supplied with a common voltage and the pixel electrode 191 is supplied with a data voltage, an electric field, which is perpendicular to the surfaces of the two panels 100 and 200, is generated in the LC layer 3. In response to the electric field, the LC molecules in the LC layer 3 begin to change their orientation to be perpendicular to the direction of the electric field.

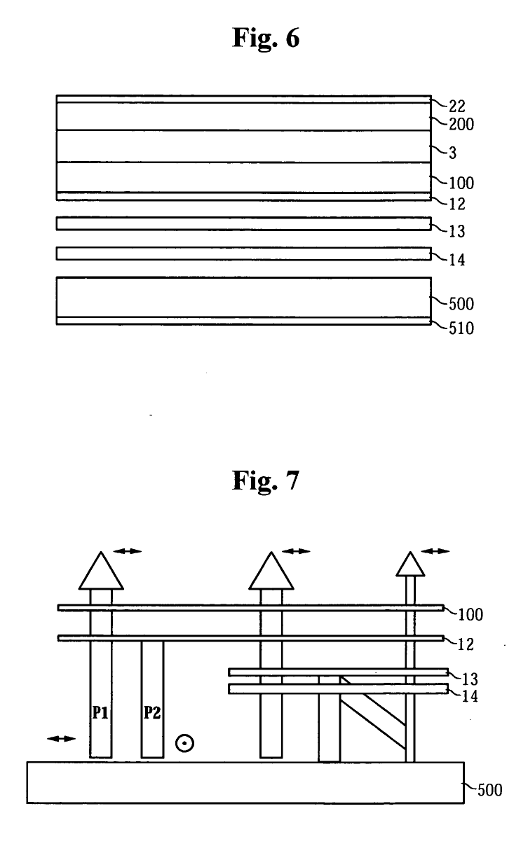

FIG. 6 shows a schematic cross-sectional view of an LCD according to an embodiment of the present invention.

The LCD further comprises an absorbing polarizer 12, a reflective polarizer 13, an optical retarder 14, and a backlight unit 500, besides the TFT array panel 100, the common electrode panel 200, and the LC layer 3 shown in FIG. 1 through FIG. 5.

Referring to FIG. 6, the absorbing polarizer 12 is attached to a lower surface of the TFT array panel 100, and the reflective polarizer 13 and the optical retarder 14 in that order are disposed under the absorbing polarizer 12. The backlight unit 500 is disposed under the optical retarder 14, and a reflective plate 510 is provided on a lower surface of the backlight unit 500.

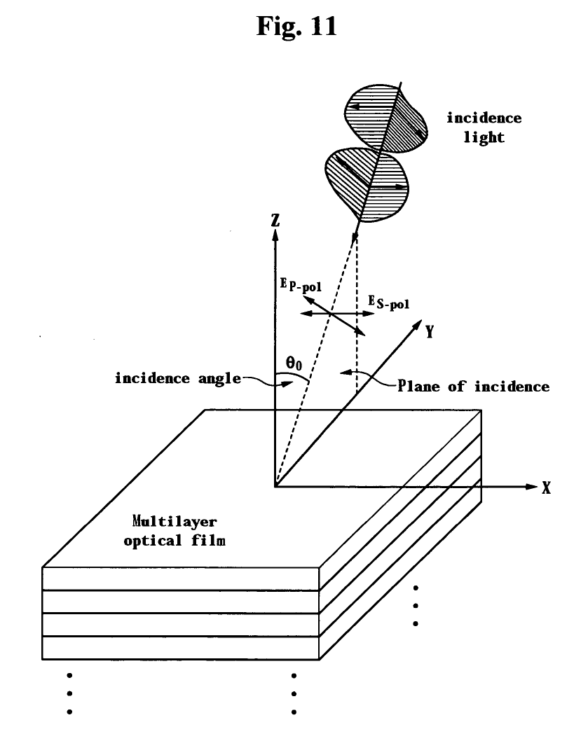

The reflective polarizer 13 transmits linearly polarized incident light in the X direction (⇄) and reflects linearly polarized incident light in the Y direction (⊙) that is perpendicular to the X direction (⇄). The structure of the reflective polarizer 13 is shown in FIG. 11 and it will be described in detail next. Meanwhile, the absorbing polarizer 12 transmits linearly polarized incident light in the X direction (⇄) and absorbs linearly polarized incident light in the Y direction (⊙). Accordingly, light passing through the reflective polarizer 13 can also pass through the absorbing polarizer 12.

The optical retarder 14, which is disposed under the reflective polarizer 13, has a slow axis and a fast axis. Accordingly light passing through the fast axis obtains a faster phase than that of light passing through the slow axis. In this embodiment, a phase difference between the two axes is a quarter-wave to convert circularly polarized light into linearly polarized light or linearly polarized light into circularly polarized light. The two axes can be perpendicular to each other and are formed at ±45° to transmission axes of the polarizers 12, 22, and 13, respectively.

FIG. 7 is a view for comparing light efficiency and light paths between portions with and without a reflective polarizer and an optical retarder in an LCD according to the present invention.

The left half of FIG. 7 shows a portion of the LCD with only the absorbing polarizer 12 without the reflective polarizer 13 and the optical retarder 14. In this case, only light in the X direction (⇄) can be used for the display. Whereas, in the case that the polarizers 12 and 13 and the optical retarder 14 are all provided between the panel 100 and backlight unit 500, as shown in the right half of FIG. 7, light in the Y direction (⊙) can also be used for the display together with the light in the X direction (⇄) by a recycling process of the light.

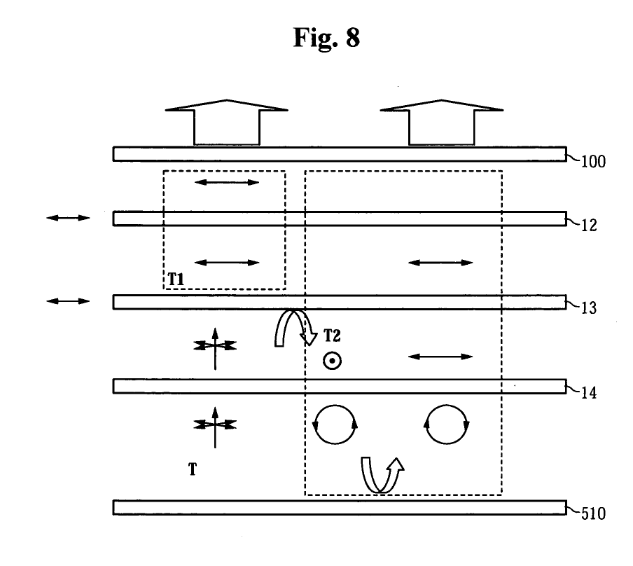

FIG. 8 shows the polarization states of light in the LCD of FIG. 6. This figure shows only primary components that have influence on the polarization of light so that the light emitted from the backlight unit 500 is incident onto the TFT array panel 100.

Referring to FIG. 8 light (T) emitted from the backlight unit 500 is incident onto the optical retarder 14, emanating in all directions. The optical retarder 14 transmits all incident light (T) without polarization. The light is then incident onto the reflective polarizer 13. The reflective polarizer 13 transmits only light in the X direction (⇄) of the incident light (T), and reflects light in the Y direction (⊙). Hereinafter, succeeding paths of the light (T1) passing through the reflective polarizer 13 and the light (T2) reflected by the reflective polarizer 13 are separately described.

The transmitted light (T1) is incident onto the absorbing polarizer 12, and then passes through the polarizer 12 since a transmission axis of the polarizer 12 is in the X direction (⇄). The light (T1) is then incident onto the TFT array panel 100.

On the other hand, the light reflected (T2) by the reflective polarizer 13 is incident onto the optical retarder 14 again. The light (T2) then passes through the optical retarder 14. The light (T2) is converted to left-handed circularly polarized light by the optical retarder 14. The left-handed circularly polarized light is incident onto the reflective plate 510 of the backlight unit 500, and is then reflected by the reflective plate 510. With the reflection, the left-handed circularly polarized light is converted to right-handed circularly polarized light. Then, the right-handed circularly polarized light passes through the optical retarder 14. The right-handed circularly polarized light is converted to linearly polarized light in the X direction (⇄).

Since the reflected light (T2) is converted to the linearly polarized light in the X direction in this manner, it can meet the TFT array panel 100 after passing through the reflective polarizer 13 and the absorbing polarizer 12. In this way, the light that would be ordinarily removed by absorption in conventional LCDs is recycled for the display in the present invention, so that light efficiency and display luminance of the LCD are improved.

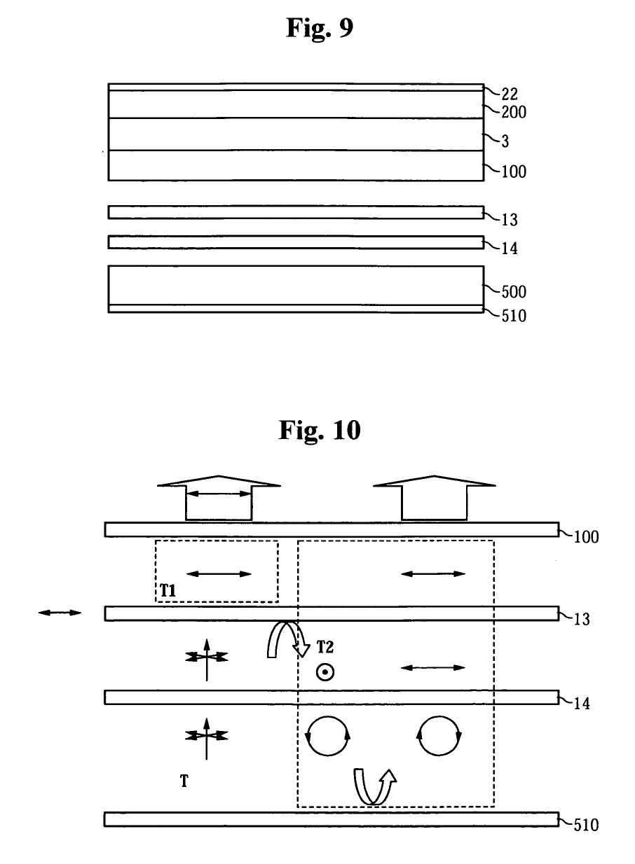

FIG. 9 shows a schematic cross-sectional view of an LCD according to another embodiment of the present invention.

The LCD of FIG. 9 omits the absorbing polarizer 12 of FIG. 6. This is possible because transmission axes of the reflective polarizer 13 and the absorbing polarizer 13 are in the same direction (⇄) and therefore the two polarizers 12 and 13 serve in similar manners.

The LCD without the absorbing polarizer 12 is characterized as follows.

Generally, the absorbing polarizers show higher polarization efficiency than the reflective polarizers. Therefore, the LCD incorporating the absorbing polarizer 12 can display images more vividly than the LCD without it. However, the LCD without the absorbing polarizer 12 has a reduced manufacturing cost and a simplified manufacturing process.

Therefore, the embodiment additionally utilizing the absorbing polarizer 12 can be applied to LCDs requiring higher display quality, and the embodiment omitting the absorbing polarizer 12 can be applied to LCDs requiring lower manufacturing cost.

FIG. 10 shows the polarization states of light in the LCD of FIG. 9. The polarization states of light shown in FIG. 10 are equal to that of FIG. 8, excepting that the absorbing polarizer 12 is omitted.

Hereinafter, the reflective polarizer 13 is described in detail.

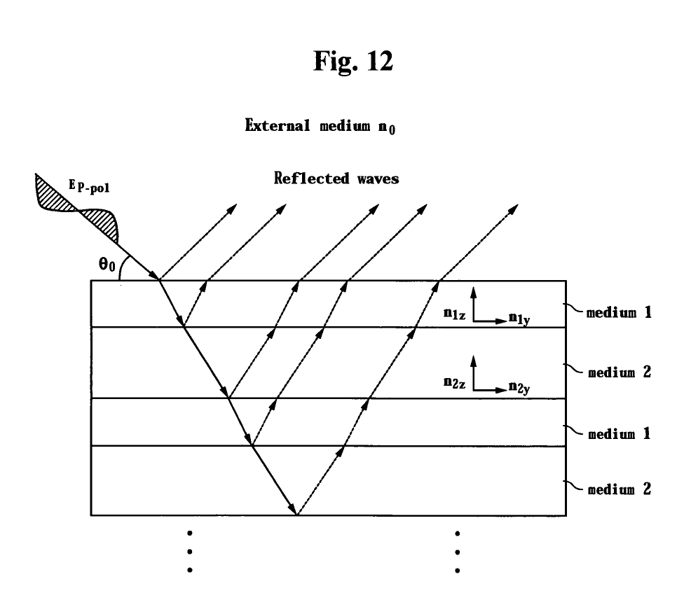

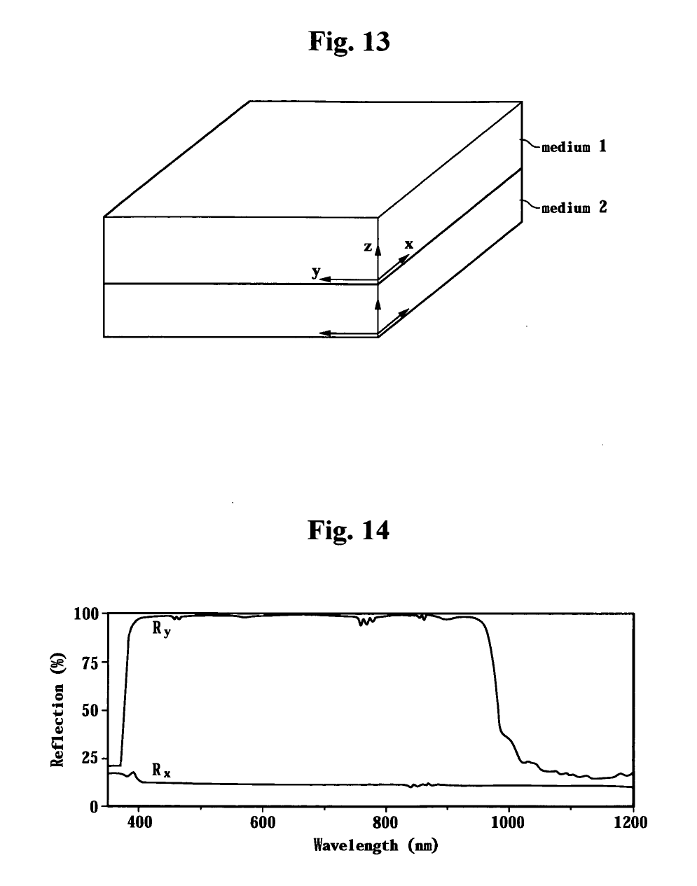

FIG. 11 is a perspective view of a reflective polarizer according to an embodiment of the present invention, FIG. 12 shows an optical path of light reflected by the reflective polarizer of FIG. 11, FIG. 13 is a perspective view showing a basic structure of the reflective polarizer of FIG. 11, and FIG. 14 is a graph showing reflection and transmission characteristics of the reflective polarizer of FIG. 11.

Referring to FIG. 1 1 though FIG. 13, the reflective polarizer 13 is made of alternating layers (ABAB . . . ) of two different media. The two media A and B have different indices of refraction in one direction and the same index of refraction in another direction. At an interface between the two media A and B, only a partial portion of light that is incident in the direction where the two media A and B have the different refractive indices is reflected and the remaining portion is transmitted, while light that is incident in the direction where the two media A and B have the same refractive index is all transmitted. These phenomena occur at every interface of the two media A and B. As a result, light that is incident onto the reflective polarizer 13 in the direction where the two media A and B have the same refractive index is all transmitted, while light that is incident onto the reflective polarizer 13 in the direction where the two media A and B have the different refractive indices is mostly reflected.

For instance, when two media A and B with refractive characteristics as indicated in below Table 1 were used for the formation of the reflective polarizer 13, the resulting reflective polarizer actually showed the transmission and reflection characteristics of FIG. 14.

TABLE 1

| | Medium A | Medium B |
|---|---|---|
| Index of refraction (x-direction) | 1.57 | 1.57 |
| Index of refraction (y-direction) | 1.86 | 1.57 |
| Index of refraction (z-direction) | 1.57 | 1.57 |

The x-, y-, and z-directions of Table 1 are equivalent to those of FIG. 13.

A graph of FIG. 14 shows that the light in the x-direction where the two media A and B have the same refractive index is slightly reflected, while the light in the y-direction where the two media A and B have different refractive indices is nearly 100% reflected.

For the above-mentioned reflective polarizer 13, a double brightness enhancement film can be used.

Meanwhile, in the above-mentioned embodiment, the optical retarder 14 is disposed under the reflective polarizer 13. Alternatively, the reflective polarizer and optical retarder can be integrally formed.

In this case, the optical retarder may be obtained by curing LC molecules. In particular, a photosensitive alignment layer is coated on a lower surface of a reflective polarizer and then exposed to light in order to form an alignment axis. After the formation of the alignment axis, LC molecules are coated thereon and then cured, so that an optical retarder is completed on the reflected polarizer. The optical retarder formed in such a manner is significantly thinner than the optical retarder 14 separately produced. This optical retarder also has a slow axis and a fast axis. Either of the two axes can be formed at ±45° to the transmission axis of the reflective polarizer.

In the above-illustrated embodiments of the present invention, the common electrode 270 is formed in the common electrode panel 200. However, the present invention is also applicable to the structure where the common electrode and pixel electrodes are formed in the same panel.

According to an embodiment of the present invention, the reflective polarizer and optical retarder are provided between the absorbing polarizer and the backlight unit, as mentioned in the above. This structure can recycle light that would ordinarily be absorbed by the absorbing polarizer in the conventional LCDs to be used for the display. As a result, light efficiency and display luminance of the LCD are improved.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A liquid crystal display comprising:
a display panel;
a reflective polarizer that is provided under the display panel to transmit light linearly polarized in a first direction and to reflect light linearly polarized in a second direction perpendicular to the first direction;
an optical retarder that is provided under the reflective polarizer; and
a backlight unit that is provided under the optical retarder and includes a light source for supplying light to the display panel,
wherein the reflective polarizer is made of alternating layers of two media have same index of refraction in the first direction and the different indices of refraction in the second direction.

2. The liquid crystal display of claim 1, further comprising a first absorbing polarizer that is provided between the display panel and the reflective polarizer.

3. The liquid crystal display of claim 2, wherein a transmission axis of the first absorbing polarizer is in the first direction.

4. The liquid crystal display of claim 3, further comprising a second absorbing polarizer that is attached to an upper surface of the display panel.

5. The liquid crystal display of claim 4, wherein a transmission axis of the second absorbing polarizer is in the second direction.

6. The liquid crystal display of claim 1, wherein the optical retarder has a slow axis and a fast axis, and a phase difference between the two axes is a quarter-wave to convert circularly polarized light into linearly polarized light or linearly polarized light into circularly polarized light.

7. The liquid crystal display of claim 6, wherein the fast axis or the slow axis of the optical retarder is formed at ±45° to the first direction or the second direction.

8. The liquid crystal display of claim 1, wherein the backlight unit includes a reflective plate for reflecting light toward the display panel that is provided above the backlight unit.

9. A liquid crystal display comprising:
a display panel;
a reflective polarizer that is provided under the display panel and includes a selective reflection film that transmits light linearly polarized in a first direction and reflects light linearly polarized in a second direction perpendicular to the first direction and an optical retardation film that is coated on a lower surface of the selective reflection film; and
a backlight unit that is provided under the reflective polarizer and includes a light source for supplying light to the display panel,
wherein the reflective polarizer is made of alternating layers of two media have same index of refraction in the first direction and the different indices of refraction in the second direction.

10. The liquid crystal display of claim 9, further comprising a first absorbing polarizer that is provided between the display panel and the reflective polarizer.

11. The liquid crystal display of claim 10, wherein a transmission axis of the first absorbing polarizer is in the first direction.

12. The liquid crystal display of claim 11, further comprising a second absorbing polarizer that is attached to an upper surface of the display panel.

13. The liquid crystal display of claim 12, wherein a transmission axis of the second absorbing polarizer is in the second direction.

14. The liquid crystal display of claim 9, wherein the optical retardation film has a slow axis and a fast axis, and a phase difference between the two axes is a quarter-wave to convert circularly polarized light into linearly polarized light or linearly polarized light into circularly polarized light.

15. The liquid crystal display of claim 16, wherein either of the fast axis or the slow axis of the optical retardation film is formed at ±45° to the first direction or the second direction.

16. The liquid crystal display of claim 9, wherein the optical retardation film is obtained by curing liquid crystal.

17. The liquid crystal display of claim 9, wherein the backlight unit further includes a reflective plate for reflecting light toward the display panel that is provided above the backlight unit.

18. A liquid crystal display comprising:
a display panel;
a reflective polarizer that is provided under the display panel to transmit light linearly polarized in a first direction and to reflect light linearly polarized in a second direction perpendicular to the first direction;
a first absorbing polarizer having a transmission axis in the first direction that is provided between the display panel and the reflective polarizer;
a second absorbing polarizer having a transmission axis in the second direction that is attached to an upper surface of the display panel; and
a backlight unit that is provided under the optical retarder and includes a light source for supplying light to the display panel,
wherein the reflective polarizer is made of alternating layers of two media have same index of refraction in the first direction and the different indices of refraction in the second direction.

19. The liquid crystal display of claim 18, further comprising an optical retarder that is provided under the reflective polarizer.

20. The liquid crystal display of claim 18, wherein said reflective polarizer comprises a selective reflection film that transmits light linearly polarized in a first direction and reflects light linearly polarized in a second direction perpendicular to the first direction and an optical retardation film that is coated on a lower surface of the selective reflection film.
